(19) United States
(12) Patent Application Publication
(10) Pub. No.: US 2026/0040359 A1
(43) Pub. Date: Feb. 5, 2026

(54) POWER CONTROL FOR ADDITIONAL ACTIVATED RANDOM ACCESS CHANNEL OCCASIONS

(71) Applicant: QUALCOMM Incorporated, San Diego, CA (US)

(72) Inventors: Ahmed Attia ABOTABL, San Diego, CA (US); Changhwan PARK, San Diego, CA (US); Navid ABEDINI, Basking Ridge, NJ (US); Muhammad Sayed Khairy ABDELGHAFFAR, San Jose, CA (US); Wanshi CHEN, San Diego, CA (US); Hung Dinh LY, San Diego, CA (US)

(21) Appl. No.: 18/794,880

(22) Filed: Aug. 5, 2024

(51) Int. Cl. H04W 74/0833; H04W 52/32

(52) U.S. Cl. CPC H04W 74/0833; H04W 52/322

(57) ABSTRACT

Methods, systems, and devices for wireless communications are described. The network may schedule a set of random access channel (RACH) occasions (ROs). The network may activate one or more additional ROs. A UE may use a first set of power control parameters for a RACH transmission in an RO of the original set of ROs prior to activation of the one or more additional ROs. In some examples, after the activation of the additional RO(s), the UE may use a second set of power control parameters for RACH messages in both original set of ROs and the additional RO(s). In some examples, after the activation of the one or more additional ROs, the UE may use the first set of power control parameters for RACH messages in the original set of ROs and the second set of power control parameters in the additional RO(s).

### FIELD OF TECHNOLOGY

The following relates to wireless communications, including power control for additional activated random access channel occasions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control signaling that schedules a first set of random access channel (RACH) occasions (ROs), where the first control signaling indicates a first power control parameter, transmitting a first RACH message via a first RO in accordance with the first power control parameter, where the first set of ROs includes the first RO, receiving second control signaling that indicates activation of an additional RO, and transmitting a second RACH message via a second RO in accordance with a second power control parameter based on the activation of the additional RO.

A UE for wireless communications is described. The UE may include one or more memories storing processor executable code, and one or more processors coupled with the one or more memories. The one or more processors may individually or collectively be operable to execute the code to cause the UE to receive first control signaling that schedules a first set of ROs, where the first control signaling indicates a first power control parameter, transmit a first RACH message via a first RO in accordance with the first power control parameter, where the first set of ROs includes the first RO, receive second control signaling that indicates activation of an additional RO, and transmit a second RACH message via a second RO in accordance with a second power control parameter based on the activation of the additional RO.

Another UE for wireless communications is described. The UE may include means for receiving first control signaling that schedules a first set of ROs, where the first control signaling indicates a first power control parameter, means for transmitting a first RACH message via a first RO in accordance with the first power control parameter, where the first set of ROs includes the first RO, means for receiving second control signaling that indicates activation of an additional RO, and means for transmitting a second RACH message via a second RO in accordance with a second power control parameter based on the activation of the additional RO.

A non-transitory computer-readable medium storing code for wireless communications is described. The code may include instructions executable by one or more processors to receive first control signaling that schedules a first set of ROs, where the first control signaling indicates a first power control parameter, transmit a first RACH message via a first RO in accordance with the first power control parameter, where the first set of ROs includes the first RO, receive second control signaling that indicates activation of an additional RO, and transmit a second RACH message via a second RO in accordance with a second power control parameter based on the activation of the additional RO.

In some examples of the method, UEs, and non-transitory computer-readable medium described herein, the first set of ROs includes the second RACH message.

Some examples of the method, UEs, and non-transitory computer-readable medium described herein may further include operations, features, means, or instructions for transmitting a third RACH message via a third RO in accordance with the second power control parameter and based on the activation of the additional RO, where the additional RO includes the first RO.

In some examples of the method, UEs, and non-transitory computer-readable medium described herein, transmitting the second RACH message may include operations, features, means, or instructions for transmitting the second RACH message in accordance with the second power control parameter based on the additional RO including the second RO.

Some examples of the method, UEs, and non-transitory computer-readable medium described herein may further include operations, features, means, or instructions for transmitting, subsequent to reception of the second control signaling, a third RACH message via a third RO in accordance with the first power control parameter based on the first set of ROs including the third RO.

Some examples of the method, UEs, and non-transitory computer-readable medium described herein may further include operations, features, means, or instructions for resetting a power control accumulator parameter based on the activation, where the second power control parameter includes the power control accumulator parameter.

Some examples of the method, UEs, and non-transitory computer-readable medium described herein may further include operations, features, means, or instructions for receiving, subsequent to transmission of the second RACH message, third control signaling that indicates deactivation of the additional RO and transmitting, subsequent to reception of the third control signaling, a third RACH message via a third RO in accordance with the first power control parameter based on the deactivation of the additional RO, where the first set of ROs includes the third RO.

Some examples of the method, UEs, and non-transitory computer-readable medium described herein may further include operations, features, means, or instructions for resetting a power control accumulator parameter based on the activation, where the first power control parameter includes the power control accumulator parameter.

In some examples of the method, UEs, and non-transitory computer-readable medium described herein, the first power control parameter includes a first ramping increment between subsequent RACH messages and the second power control parameter includes a second ramping increment between subsequent RACH messages different from the first ramping increment between subsequent RACH messages.

In some examples of the method, UEs, and non-transitory computer-readable medium described herein, the second power control parameter includes a power offset with respect to the first power control parameter.

In some examples of the method, UEs, and non-transitory computer-readable medium described herein, the first power control parameter includes a first maximum transmission power and the second power control parameter includes a second maximum transmission power different than the first maximum transmission power.

Some examples of the method, UEs, and non-transitory computer-readable medium described herein may further include operations, features, means, or instructions for receiving, via the first control signaling or the second control signaling, an indication of the second power control parameter.

A method for wireless communications by a network entity is described. The method may include transmitting, to a UE, first control signaling that schedules a first set of ROs, where the first control signaling indicates a first power control parameter, receiving, from the UE, a first RACH message via a first RO in accordance with the first power control parameter, where the first set of ROs includes the first RO, transmitting, to the UE, second control signaling that indicates activation of an additional RO, and receiving, from the UE, a second RACH message via a second RO in accordance with a second power control parameter based on the activation of the additional RO.

A network entity for wireless communications is described. The network entity may include one or more memories storing processor executable code, and one or more processors coupled with the one or more memories. The one or more processors may individually or collectively be operable to execute the code to cause the network entity to transmit, to a UE, first control signaling that schedules a first set of ROs, where the first control signaling indicates a first power control parameter, receive, from the UE, a first RACH message via a first RO in accordance with the first power control parameter, where the first set of ROs includes the first RO, transmit, to the UE, second control signaling that indicates activation of an additional RO, and receive, from the UE, a second RACH message via a second RO in accordance with a second power control parameter based on the activation of the additional RO.

Another network entity for wireless communications is described. The network entity may include means for transmitting, to a UE, first control signaling that schedules a first set of ROs, where the first control signaling indicates a first power control parameter, means for receiving, from the UE, a first RACH message via a first RO in accordance with the first power control parameter, where the first set of ROs includes the first RO, means for transmitting, to the UE, second control signaling that indicates activation of an additional RO, and means for receiving, from the UE, a second RACH message via a second RO in accordance with a second power control parameter based on the activation of the additional RO.

A non-transitory computer-readable medium storing code for wireless communications is described. The code may include instructions executable by one or more processors to transmit, to a UE, first control signaling that schedules a first set of ROs, where the first control signaling indicates a first power control parameter, receive, from the UE, a first RACH message via a first RO in accordance with the first power control parameter, where the first set of ROs includes the first RO, transmit, to the UE, second control signaling that indicates activation of an additional RO, and receive, from the UE, a second RACH message via a second RO in accordance with a second power control parameter based on the activation of the additional RO.

In some examples of the method, network entities, and non-transitory computer-readable medium described herein, the first set of ROs includes the second RACH message.

Some examples of the method, network entities, and non-transitory computer-readable medium described herein may further include operations, features, means, or instructions for receiving, from the UE, a third RACH message via a third RO in accordance with the second power control parameter and based on the activation of the additional RO, where the additional RO includes the first RO.

In some examples of the method, network entities, and non-transitory computer-readable medium described herein, receiving the second RACH message may include operations, features, means, or instructions for receiving the second RACH message in accordance with the second power control parameter based on the additional RO including the second RO.

Some examples of the method, network entities, and non-transitory computer-readable medium described herein may further include operations, features, means, or instructions for receiving, from the UE subsequent to reception of the second control signaling, a third RACH message via a third RO in accordance with the first power control parameter based on the first set of ROs including the third RO.

Some examples of the method, network entities, and non-transitory computer-readable medium described herein may further include operations, features, means, or instructions for transmitting, to the subsequent to transmission of the second RACH message, third control signaling that indicates deactivation of the additional RO and receiving, from the UE subsequent to reception of the third control signaling, a third RACH message via a third RO in accordance with the first power control parameter based on the deactivation of the additional RO, where the first set of ROs includes the third RO.

In some examples of the method, network entities, and non-transitory computer-readable medium described herein, the first power control parameter includes a first ramping increment between subsequent RACH messages and the second power control parameter includes a second ramping increment between subsequent RACH messages different from the first ramping increment between subsequent RACH messages.

In some examples of the method, network entities, and non-transitory computer-readable medium described herein, the second power control parameter includes a power offset with respect to the first power control parameter.

In some examples of the method, network entities, and non-transitory computer-readable medium described herein, the first power control parameter includes a first maximum transmission power and the second power control parameter includes a second maximum transmission power different than THE first maximum transmission power.

Some examples of the method, network entities, and non-transitory computer-readable medium described herein may further include operations, features, means, or instructions for transmitting, to the UE via the first control signaling or the second control signaling, an indication of the second power control parameter.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports power control for additional activated random access channel (RACH) occasions (ROs) in accordance with one or more aspects of the present disclosure.

FIG. 2 shows an example of a wireless communications system that supports power control for additional activated ROs in accordance with one or more aspects of the present disclosure.

FIG. 3 shows an example of an RO timing diagram that supports power control for additional activated ROs in accordance with one or more aspects of the present disclosure.

FIG. 4 shows an example of a process flow that supports power control for additional activated ROs in accordance with one or more aspects of the present disclosure.

FIGS. 5 and 6 show block diagrams of devices that support power control for additional activated ROs in accordance with one or more aspects of the present disclosure.

FIG. 7 shows a block diagram of a communications manager that supports power control for additional activated ROs in accordance with one or more aspects of the present disclosure.

FIG. 8 shows a diagram of a system including a device that supports power control for additional activated ROs in accordance with one or more aspects of the present disclosure.

FIGS. 9 and 10 show block diagrams of devices that support power control for additional activated ROs in accordance with one or more aspects of the present disclosure.

FIG. 11 shows a block diagram of a communications manager that supports power control for additional activated ROs in accordance with one or more aspects of the present disclosure.

FIG. 12 shows a diagram of a system including a device that supports power control for additional activated ROs in accordance with one or more aspects of the present disclosure.

FIGS. 13 and 14 show flowcharts illustrating methods that support power control for additional activated ROs in accordance with one or more aspects of the present disclosure.

### DETAILED DESCRIPTION

A user equipment (UE) may transmit a random access channel (RACH) message (e.g., a msg1 or and msgA) in a RACH occasion (RO) to perform initial access with a network entity and/or to maintain ongoing communications with the network entity. The network entity may indicate resources for a set of ROs. The UE may transmit a RACH message in accordance with a set of power control parameters. For example, if a first RACH message in a first RO fails (e.g., the UE does not receive a response from the network entity), the UE may increment the transmission power for a subsequent RACH message in a second RO. The initial transmission power, the increment, and a maximum transmission power may be configured as the first set of power control parameters. One or more additional ROs may activatable by the network for some UEs. The additional ROs may be transparent to some UEs. For example, the network entity may activate additional ROs based on traffic demand in order to save energy. For example, the network entity may save energy by refraining from monitoring in the additional ROs unless the additional ROs are activated. UEs which may use the additional ROs may be referred to as network energy saving (NES)-capable UEs. UEs to which the additional activatable ROs are transparent or which may not use the additional activatable ROs may be referred to as non-NES-capable UEs.

Aspects of this disclosure relate to the use of different power control parameters before and after the activation of additional ROs that are available to some UEs (e.g., the NES-capable UEs). A UE may use a first set of power control parameters for a RACH transmission in an RO of the original set of ROs prior to activation of the set of additional ROs, where the set of additional ROs may include one or more ROs. For example, the network entity may transmit control signaling (e.g., radio resource control (RRC) signaling or system information (SI) that indicates the original set of ROs). In some examples, after the activation of the set of additional ROs, the UE may use a second set of power control parameters for RACH messages in both the original set of ROs and the set of additional ROs. In some examples, after the activation of the set of additional (e.g., activated) ROs, the UE may use the first set of power control parameters for RACH messages in ROs of the original set of ROs and may use the second set of power control parameters in the ROs of the set of additional (e.g., activated) ROs. The second set of power control parameters may include one or more of an offset with respect to the first set of power control parameters, a different maximum transmission power, resetting of the increment accumulator, or a different increment step.

Aspects of the disclosure are initially described in the context of wireless communications systems. Aspects of the disclosure are further illustrated by and described with reference to RO timing diagrams, process flows, apparatus diagrams, system diagrams, and flowcharts that relate to power control for additional activated ROs.

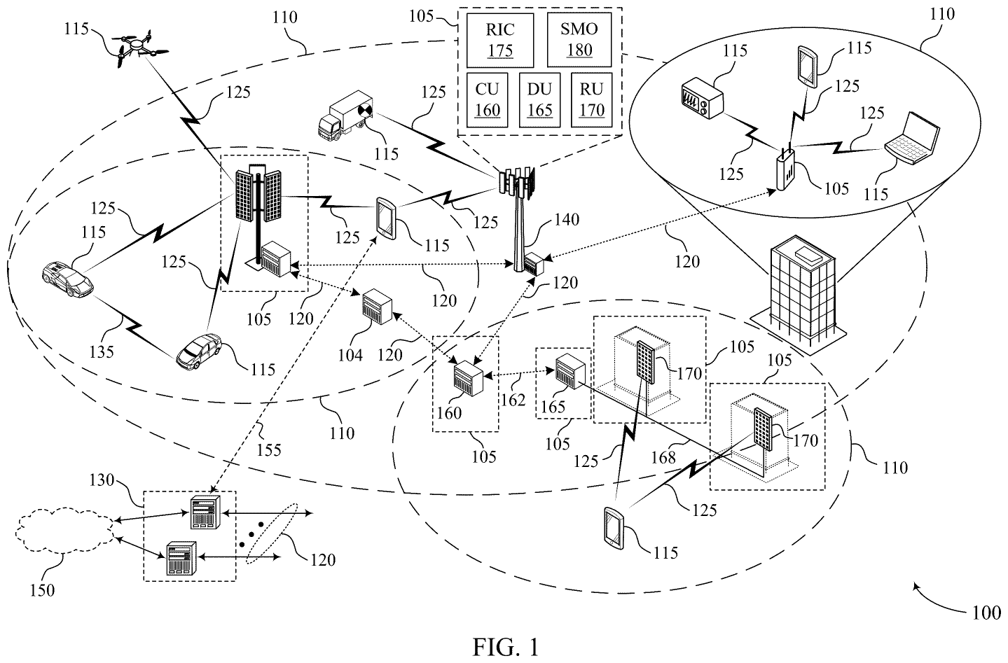

FIG. 1 shows an example of a wireless communications system 100 that supports power control for additional activated ROs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In the wireless communications system 100, a UE 115 may transmit a RACH message in an RO to perform initial access with a network entity 105 and/or to maintain ongoing communications with the network entity 105. The network entity 105 may indicate resources for a set of ROs. The UE 115 may transmit a RACH message in accordance with a set of power control parameters. For example, a UE 115 may determine a transmission power for a RACH transmission, PRACH_{b,f,c} (i), on the active uplink bandwidth part (BWP) b of carrier f on serving cell C based on the downlink reference signal for the serving cell C in the transmission occasion i as shown in Equation 1. In Equation 1, P_{CMAX,f,c} (i) may be the UE 115 configured maximum output power for the carrier f of serving cell C within transmission occasion i. For example, P_{CMAX,f,c} (i) may be defined in higher layers such as RRC signaling or SI (e.g., the master information block (MIB) in a synchronization signal block (SSB) or another SI block (SIB)) received from the network entity 105 for the UE 115. P_{PRACHtarget,f,c} may be the physical RACH (PRACH) target reception power PREAMBLE_RECEIVED_TARGET_POWER provided to the UE 115 by higher layer signaling such as RRC signaling or SI for the active uplink BWP b of carrier f on serving cell C, and PL_{b,f,c} may be a pathloss for the active uplink BWP b of carrier f on serving cell C (e.g., determined based on SSB measurements). PREAMBLE_RECEIVED_TARGET_POWER may be set to the preambleReceivedTargetPower+DELTA_PREAMBLE+ (PREAMBLE_POWER_RAMPING_COUNTER−1)×PREAMBLE_POWER_RAMPING_COUNTER−1+POWER_OFFSET_2STEP_RA. For example, if a first RACH message in a first RO fails (e.g., the UE 115 does not receive a response from the network entity 105), the UE 115 may increment the transmission power for a subsequent RACH message in a second RO (e.g., by the ramping increment).

$$P R A C {H}_{b , f , c} ( i ) = min \{ {P}_{C M A X , f , c} ( i ) , {P}_{PRACH target , f , c} + P {L}_{b , f , c} \} [ dBm ] \qquad ( 1 )$$

The initial transmission power, the ramping increment, and a maximum transmission power may be configured for the UE 115 as the first set of power control parameters. One or more additional ROs may activatable by the network entity 105 for some UEs 115 (e.g., NES-capable UEs 115 such as UEs 115 compatible with 3rd Generation Partnership Project (3GPP) Release 19 and beyond). The additional ROs may be transparent to some UEs 115 (e.g., non-NES-capable UEs 115). For example, the network entity 105 activate additional ROs based on the traffic demand to save energy. The network entity 105 may save energy by refraining from monitoring in the additional ROs unless the additional ROs are activated. Accordingly, the network entity 105 may not activate additional ROs unless the traffic demand or quantity of UEs 115 within the coverage area of the network entity exceeds a threshold. The NES-capable UEs 115 may be capable of using (e.g., transmitting RACH messages in) both the original ROs and the additional activatable ROs. The non-NES-capable UEs 115 may be capable of using the original ROs but may not be capable of using the additional activatable ROs.

In some examples, a UE 115 may use different power control parameters before and after the activation of additional ROs. The UE 115 may use a first set of power control parameters for a RACH transmission in an RO of the original set of ROs prior to activation of the set of additional ROs. For example, the network entity 105 may transmit control signaling (e.g., RRC signaling or SI) that indicates the original set of ROs). The additional ROs may be configured via semi-static signaling. The network entity 105 may activate one or more additional ROs, for example, based on traffic conditions (e.g., a quantity of UEs within the coverage area of the network entity 105). In some examples, for NES purposes, the network entity 105 may activate the additional ROs for a short window of time. In some examples, as the additional ROs may be activated for a short window of time, a UE 115 may increase transmission power in the one or more additional ROs as compared to transmission in an RO prior to activation of the additional ROs. In some examples, after the activation of the one or more additional ROs, the UE 115 may use a second set of power control parameters for RACH messages in both original set of ROs and the set of additional ROs. In some examples, after the activation of the one or more additional (e.g., activated) ROs, the UE 115 may use the first set of power control parameters for RACH messages in ROs of the original set of ROs and may use the second set of power control parameters in the set of additional (e.g., activated) ROs. The second set of power control parameters may include one or more of an offset with respect to the first set of power control parameters, a different maximum transmission power, resetting of the increment accumulator, or a different increment step.

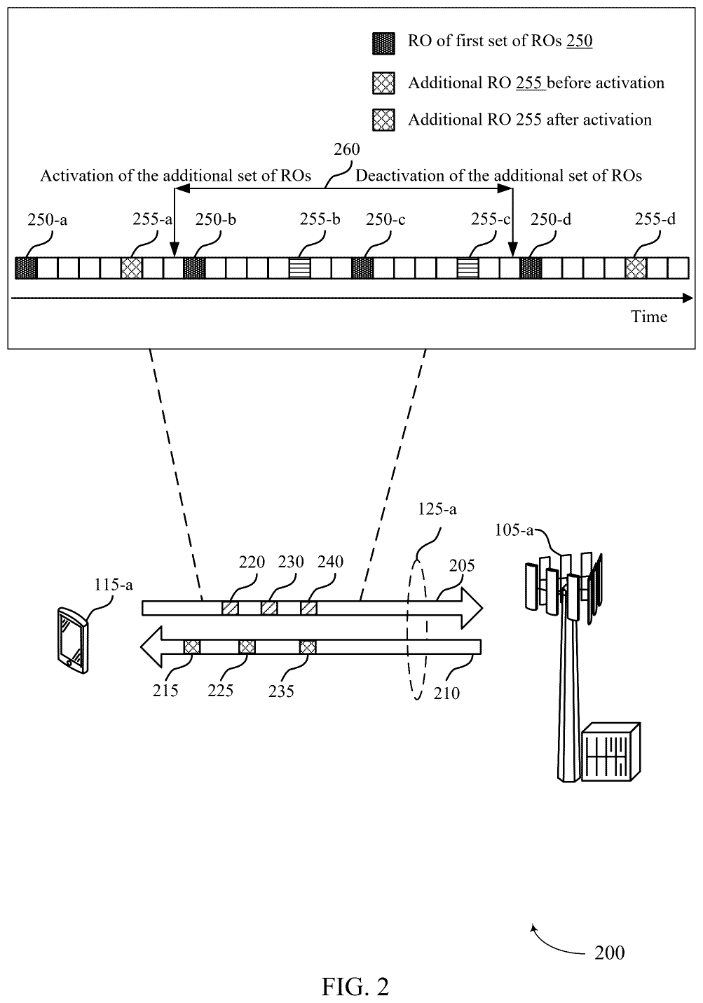

FIG. 2 shows an example of a wireless communications system 200 that supports power control for additional activated ROs in accordance with one or more aspects of the present disclosure. The wireless communications system 200 may implement or may be implemented by aspects of the wireless communications system 100. For example, the wireless communications system 200 includes a UE 115-a and a network entity 105-a, which may be examples of a UE 115 and a network entity 105 described with respect to FIG. 1.

The network entity 105-a may communicate with the UE 115-a via a communication link 125-a, which may be an example of an NR or LTE link between the UE 115-a and the network entity 105-a. In some cases, the communication link 125-a may include an example of an access link (e.g., a Uu link). The communication link 125-a may include a bi-directional link that enables both uplink and downlink communication. For example, the UE 115-a may transmit uplink signals 205, such as uplink control signals or uplink data signals, to the network entity 105-a using the communication link 125-a, and the network entity 105-a may transmit downlink signals 210, such as downlink control signals or downlink data signals, to the UE 115-a using the communication link 125-a.

The network entity 105-a may transmit control signaling 215 (e.g., higher layer signaling such as RRC signaling or SI) that indicates scheduling information for a first set of ROs 250 (e.g., an RO 250-a, an RO 250-b, an RO 250-c, and an RO 250-d). The first set of ROs may be used by NES-capable UEs 115 and non-NES-capable UEs 115. In some examples, the control signaling 215 may also indicate scheduling information for a set of additional ROs 255 (e.g., an RO 255-a, an RO 255-b, an RO 255-c, and an RO 255-d) which may activatable. In some examples, the first set of ROs 250 and the set of additional ROs 255 may be scheduled via a same control message (e.g., the control signaling 215 may include a same control message that includes the scheduling information for the first set of ROs 250 and the set of additional ROs 255). In some examples, the first set of ROs 250 and the set of additional ROs 255 may be scheduled via separate control messages (e.g., the control signaling 215 may include separate control messages that include the scheduling information for the first set of ROs 250 and the set of additional ROs 255). In some examples, the control signaling 215 may indicate a set of power control parameters associated with RACH transmissions in the first set of ROs 250.

The UE 115-a may transmit a RACH message 220 (e.g., a msg1 or a msgA) in the RO 250-a which may be one of the first set of ROs 250. After the UE 115-a transmits the RACH message 220, the network entity 105-a may transmit second control signaling 225 that activates the set of additional ROs. The UE 115-a may receive the second control signaling 225 after an RO 255-a of the set of additional ROs 255. Accordingly, the UE 115-a may not transmit a RACH message in the RO 255-a as the RO 255-a was not activated.

In some examples, the UE 115-a may use a different set of power control parameters for transmission of RACH messages after the activation of the set of additional ROs 255 via the second control signaling 225. For example, the UE 115-a may transmit a RACH message 230 in the RO 250-b or the RO 255-b after the activation of the set of additional ROs 255 via the second control signaling 225 using a second set of power control parameters different from the set of power control parameters used for the RACH message 220 prior to the activation of the set of additional ROs 255 via the second control signaling 225. After the network entity 105-a transmits the second control signaling 225 that activates the set of additional ROs 255, the network entity 105-a may transmit third control signaling 235 that may deactivate the set of additional ROs 255. For example, the network entity 105-a may deactivate the set of additional ROs based on a traffic load. In some examples, the second control signaling 225 may activate the set of additional ROs for a time window 260, and the set of additional ROs 255 may be deactivated at the end of the time window 260.

In some examples, the second set of power control parameters may include a different power ramping step as compared to the first set of power control parameters. In some examples, the UE 115-a may use the second set of power control parameters for a RACH transmission (e.g., a PRACH process) that starts after the activation of the set of additional ROs and does not end before the deactivation of the set of additional ROs. In some examples, the second set of power control parameters may include a power offset (e.g., applied to the P_{PRACHtarget,f,c}+PL_{b,f,c} term of the PRACH transmission power equation (e.g., Equation 1)) that is applied after activation of the set of additional ROs. In some examples, the UE 115-a may remove the offset (e.g., may not apply the offset) in a RACH message 240 in an RO 250-d after the deactivation of the set of additional ROs. In some examples, the UE 115-a may reset the accumulator (e.g., may reset the power ramping to an initial value) upon activation. For example, the UE 115-a may transmit a RACH message 230 in an RO of the first set of ROs 250 or the set of additional ROs 255 after the activation of the set of additional ROs 255 (e.g., in one of the RO 250-b, the RO 255-b, the RO 250-c, or the RO 255-c) using a power transmission level in accordance with the reset accumulator. In some examples, the UE 115-a may similarly reset the accumulator upon deactivation of the set of additional ROs 255. For example, the UE 115-a may transmit a RACH message 240 in an RO 250-d using a power transmission level in accordance with the reset accumulator. In some examples, the second set of power control parameters may include a different maximum transmission power. For example, the UE 115-a may use a different P_{CMAX,f,c} (i) when the set of additional ROs 255 are activated versus when the set of additional ROs 255 are deactivated.

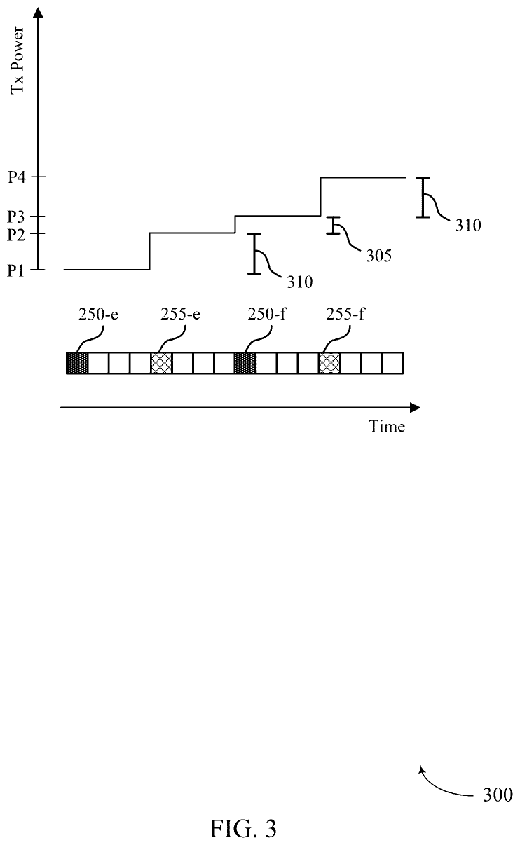

In some examples, the UE 115-a may use a different set of power control parameters for transmission of RACH messages in the set of additional ROs 255 as compared to the first set of ROs 250. For example, the UE 115-a may use the first set of power control parameters for a RACH message 230 in the RO 250-b but may use the second set of power control parameters in the RO 255-b. For example, the set of additional ROs 255 may be transparent to non-NES-capable UEs 115 and transmission in such resources may increase the interference level within the wireless communications system. Thus, the maximum transmission power in the set of additional ROs 255 may be limited (e.g., by applying an offset to the P_{CMAX,f,c} (i) used in the set of additional ROs 255 as compared to the P_{CMAX,f,c} (i) configured for the first set of ROs 250). For example, the offset to the P_{CMAX,f,c} (i) used in the set of additional ROs 255 may be indicated by SI or in an RRC configuration. In some examples, the UE 115-a may use other different power control parameters transmission of RACH messages in the set of additional ROs 255 as compared to the first set of ROs 250 (e.g., different ramping increments as shown in FIG. 3 or a different target received power (e.g., the P_{PRACHtarget,f,c} of Equation 1)).

FIG. 3 shows an example of an RO timing diagram 300 that supports power control for additional activated ROs in accordance with one or more aspects of the present disclosure. The RO timing diagram 300 may implement or may be implemented by aspects of the wireless communications system 100 or the wireless communications system 200.

In some examples, as described herein, the UE 115 may use a different set of power control parameters for transmission of RACH messages in the set of additional ROs 255 as compared to the first set of ROs 250. For example, the UE 115 may use a first ramping increment 305 for RACH messages in the first set of ROs 250 and may use a second ramping increment 310 for RACH messages in the set of additional ROs 255. For example, the UE 115 may transmit a first RACH message in the RO 250-e using a first transmission power P1. The UE 115 may determine that the first RACH message failed (e.g., the UE 115 may not receive a response from the network entity 105 for the first RACH message), and accordingly the UE 115 may transmit a second RACH message in the RO 255-e. The UE 115 may apply the second ramping increment 310 to P1 based on the second RACH message being in an RO of the set of additional ROs, and accordingly the UE 115 may transmit the second RACH message in the RO 255-e using a second transmission power level P2. The UE 115 may determine that the second RACH message failed (e.g., the UE 115 may not receive a response from the network entity 105 for the second RACH message), and accordingly the UE 115 may transmit a third RACH message in the RO 250-f. The UE 115 may apply the first ramping increment 305 to P2 based on the third RACH message being in an RO of the first set of ROs, and accordingly the UE 115 may transmit the third RACH message in the RO 250-f using a third transmission power level P3. The UE 115 may determine that the third RACH message failed (e.g., the UE 115 may not receive a response from the network entity 105 for the third RACH message), and accordingly the UE 115 may transmit a fourth RACH message in the RO 255-f. The UE 115 may apply the second ramping increment 310 to P3 based on the fourth RACH message being in an RO of the set of additional ROs, and accordingly the UE 115 may transmit the fourth RACH message in the RO 255-f using a fourth transmission power level P4. In some examples, the second ramping increment 310 may be larger than the first ramping increment 305 as less UEs 115 may attempt to use the set of additional ROs 255 (e.g., as the set of additional ROs 255 may be transparent to non-NES-capable UEs 115).

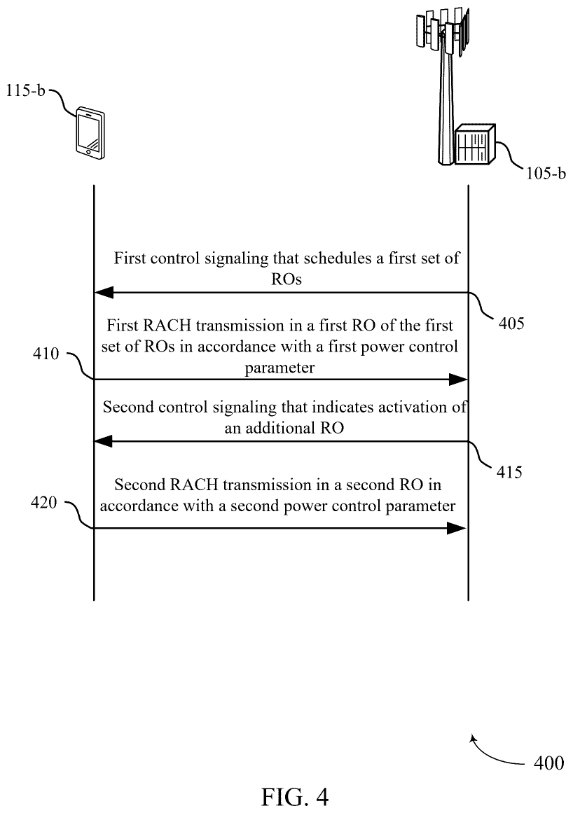

FIG. 4 shows an example of a process flow 400 that supports power control for additional activated ROs in accordance with one or more aspects of the present disclosure. The process flow 400 may include a UE 115-b and a network entity 105-b, which may be examples of a UE 115 and a network entity 105 as described herein. In the following description of the process flow 400, the communications between the network entity 105-b and the UE 115-b may be transmitted in a different order than the example order shown, or the operations performed by the network entity 105-b and the UE 115-b may be performed in different orders or at different times. Some operations may also be omitted from the process flow 400, and other operations may be added to the process flow 400.

At 405, the UE 115-b may receive, from the network entity 105-b, first control signaling that schedules a first set of ROs. The first control signaling may indicate a first power control parameter.

At 410, the UE 115-b may transmit, to the network entity 105-b, a first RACH message via a first RO in accordance with the first power control parameter. The first set of ROs may include the first RO.

At 415, the UE 115-b may receive, from the network entity 105-b, second control signaling that indicates activation of an additional RO. For example, the UE 115-b may be an NES-capable UE.

At 420, the UE 115-b may transmit, to the network entity 105-b, a second RACH message via a second RO in accordance with a second power control parameter based on the activation of the additional RO.

In some examples, the first set of ROs may include the second RACH message. In some such examples, the UE 115-b may transmit, to the network entity 105-b, a third RACH message via a third RO in accordance with the second power control parameter and based on the activation of the additional RO. In such examples, the additional RO may be the first RO.

In some examples, the UE 115-b may transmit the second RACH message in accordance with the second power control parameter based on the additional RO being the second RO. In some examples, the UE 115-b may transmit, to the network entity 105-b subsequent to reception of the second control signaling, a third RACH message via a third RO in accordance with the first power control parameter based on the first set of ROs including the third RO.

In some examples, the UE 115-b may reset a power control accumulator parameter (e.g., a power ramping parameter) based on the activation, and the second power control parameter may be the power control accumulator parameter. For example, the UE 115-b may reset the power ramping parameter to an initial value.

In some examples, the UE 115-b may receive, from the network entity 105-b subsequent to transmission of the second RACH message, third control signaling that indicates deactivation of the additional RO. In such examples, the UE 115-b may transmit, to the network entity 105-b subsequent to reception of the third control signaling, a third RACH message via a third RO in accordance with the first power control parameter based on the deactivation of the additional RO. In such examples, the first set of ROs may include the third RO. In some such examples, the UE 115-b may reset a power control accumulator parameter based on the activation, and the first power control parameter may be the power control accumulator parameter.

In some examples, the first power control parameter may be a first ramping increment between subsequent RACH messages, and the second power control parameter may be a second ramping increment between subsequent RACH messages different from the first ramping increment between subsequent RACH messages.

In some examples, the second power control parameter may be a power offset with respect to the first power control parameter.

In some examples, the first power control parameter may be a first maximum transmission power, and the second power control parameter may be a second maximum transmission power different than the first maximum transmission power.

In some examples, the UE 115-b may receive, from the network entity 105-b via the first control signaling or the second control signaling, an indication of the second power control parameter.

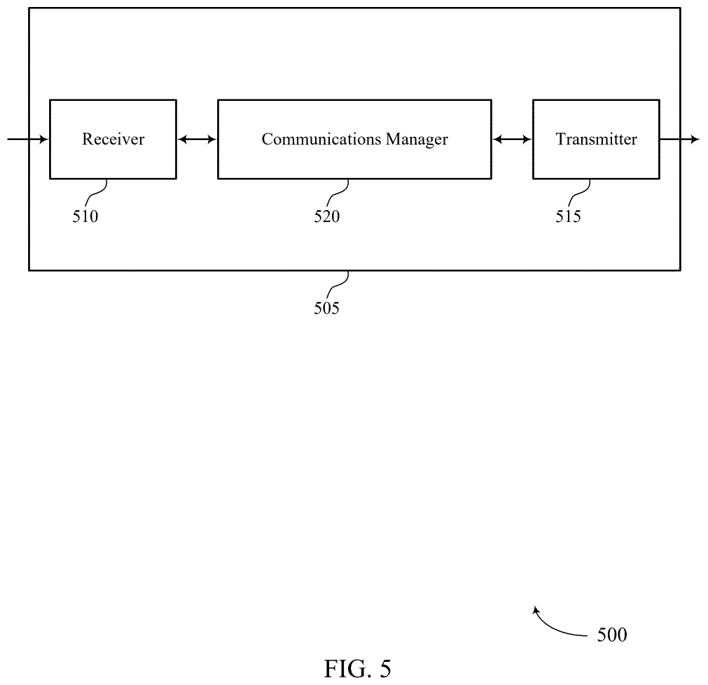

FIG. 5 shows a block diagram 500 of a device 505 that supports power control for additional activated ROs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to power control for additional activated ROs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to power control for additional activated ROS). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of power control for additional activated ROs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving first control signaling that schedules a first set of ROs, where the first control signaling indicates a first power control parameter. The communications manager 520 is capable of, configured to, or operable to support a means for transmitting a first RACH message via a first RO in accordance with the first power control parameter, where the first set of ROs includes the first RO. The communications manager 520 is capable of, configured to, or operable to support a means for receiving second control signaling that indicates activation of an additional RO. The communications manager 520 is capable of, configured to, or operable to support a means for transmitting a second RACH message via a second RO in accordance with a second power control parameter based on the activation of the additional RO.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

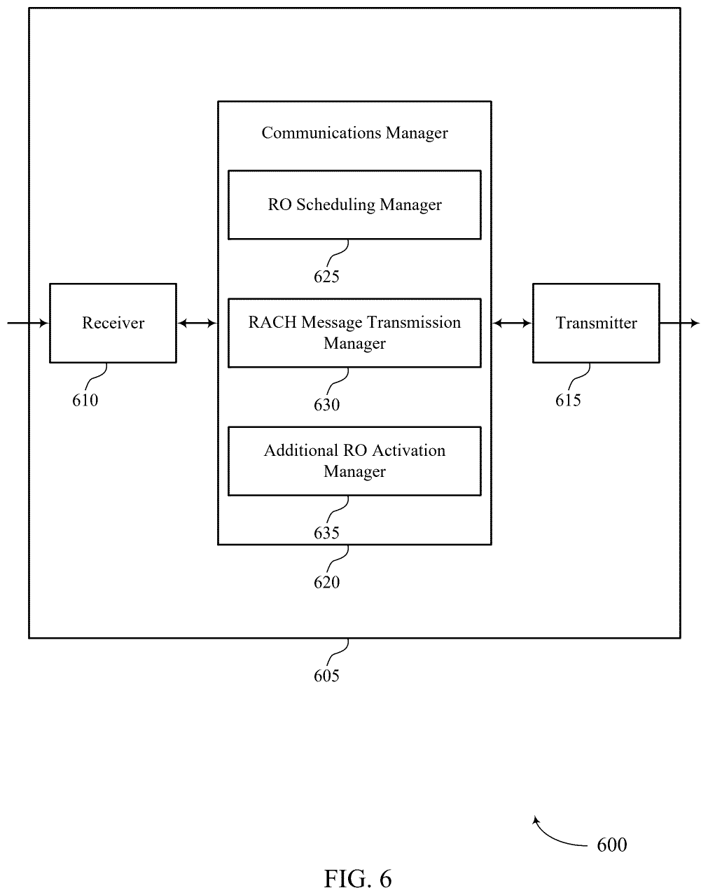

FIG. 6 shows a block diagram 600 of a device 605 that supports power control for additional activated ROs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to power control for additional activated ROs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to power control for additional activated ROs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of power control for additional activated ROS as described herein. For example, the communications manager 620 may include an RO scheduling manager 625, a RACH message transmission manager 630, an additional RO activation manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The RO scheduling manager 625 is capable of, configured to, or operable to support a means for receiving first control signaling that schedules a first set of ROs, where the first control signaling indicates a first power control parameter. The RACH message transmission manager 630 is capable of, configured to, or operable to support a means for transmitting a first RACH message via a first RO in accordance with the first power control parameter, where the first set of ROs includes the first RO. The additional RO activation manager 635 is capable of, configured to, or operable to support a means for receiving second control signaling that indicates activation of an additional RO. The RACH message transmission manager 630 is capable of, configured to, or operable to support a means for transmitting a second RACH message via a second RO in accordance with a second power control parameter based on the activation of the additional RO.

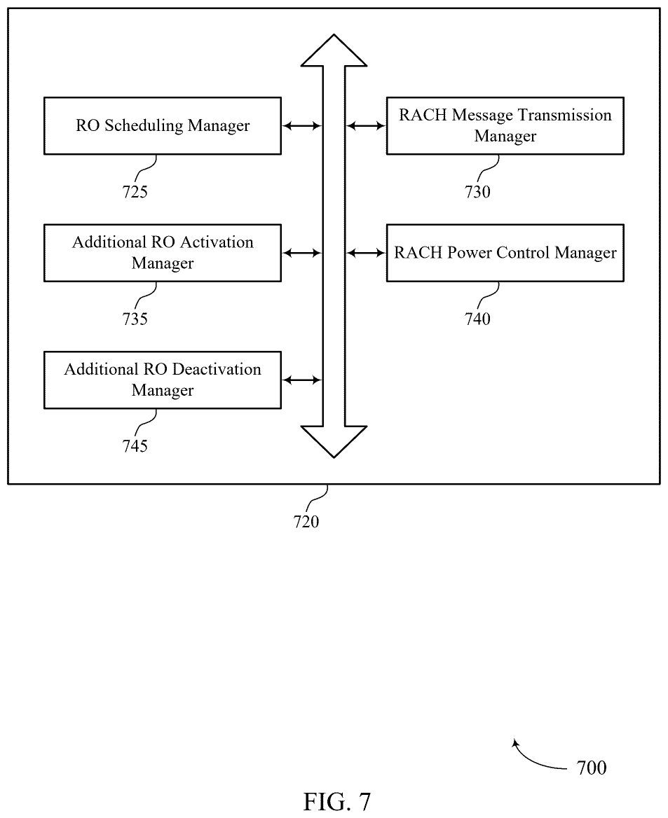

FIG. 7 shows a block diagram 700 of a communications manager 720 that supports power control for additional activated ROs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of power control for additional activated ROs as described herein. For example, the communications manager 720 may include an RO scheduling manager 725, a RACH message transmission manager 730, an additional RO activation manager 735, a RACH power control manager 740, an additional RO deactivation manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The RO scheduling manager 725 is capable of, configured to, or operable to support a means for receiving first control signaling that schedules a first set of ROs, where the first control signaling indicates a first power control parameter. The RACH message transmission manager 730 is capable of, configured to, or operable to support a means for transmitting a first RACH message via a first RO in accordance with the first power control parameter, where the first set of ROs includes the first RO. The additional RO activation manager 735 is capable of, configured to, or operable to support a means for receiving second control signaling that indicates activation of an additional RO. In some examples, the RACH message transmission manager 730 is capable of, configured to, or operable to support a means for transmitting a second RACH message via a second RO in accordance with a second power control parameter based on the activation of the additional RO.

In some examples, the first set of ROs includes the second RACH message.

In some examples, the RACH message transmission manager 730 is capable of, configured to, or operable to support a means for transmitting a third RACH message via a third RO in accordance with the second power control parameter and based on the activation of the additional RO, where the additional RO includes the first RO.

In some examples, to support transmitting the second RACH message, the RACH message transmission manager 730 is capable of, configured to, or operable to support a means for transmitting the second RACH message in accordance with the second power control parameter based on the additional RO including the second RO.

In some examples, the RACH message transmission manager 730 is capable of, configured to, or operable to support a means for transmitting, subsequent to reception of the second control signaling, a third RACH message via a third RO in accordance with the first power control parameter based on the first set of ROs including the third RO.

In some examples, the RACH power control manager 740 is capable of, configured to, or operable to support a means for resetting a power control accumulator parameter based on the activation, where the second power control parameter includes the power control accumulator parameter.

In some examples, the additional RO deactivation manager 745 is capable of, configured to, or operable to support a means for receiving, subsequent to transmission of the second RACH message, third control signaling that indicates deactivation of the additional RO. In some examples, the RACH message transmission manager 730 is capable of, configured to, or operable to support a means for transmitting, subsequent to reception of the third control signaling, a third RACH message via a third RO in accordance with the first power control parameter based on the deactivation of the additional RO, where the first set of ROs includes the third RO.

In some examples, the RACH power control manager 740 is capable of, configured to, or operable to support a means for resetting a power control accumulator parameter based on the activation, where the first power control parameter includes the power control accumulator parameter.

In some examples, the first power control parameter includes a first ramping increment between subsequent RACH messages. In some examples, the second power control parameter includes a second ramping increment between subsequent RACH messages different from the first ramping increment between subsequent RACH messages.

In some examples, the second power control parameter includes a power offset with respect to the first power control parameter.

In some examples, the first power control parameter includes a first maximum transmission power. In some examples, the second power control parameter includes a second maximum transmission power different than the first maximum transmission power.

In some examples, the RACH power control manager 740 is capable of, configured to, or operable to support a means for receiving, via the first control signaling or the second control signaling, an indication of the second power control parameter.

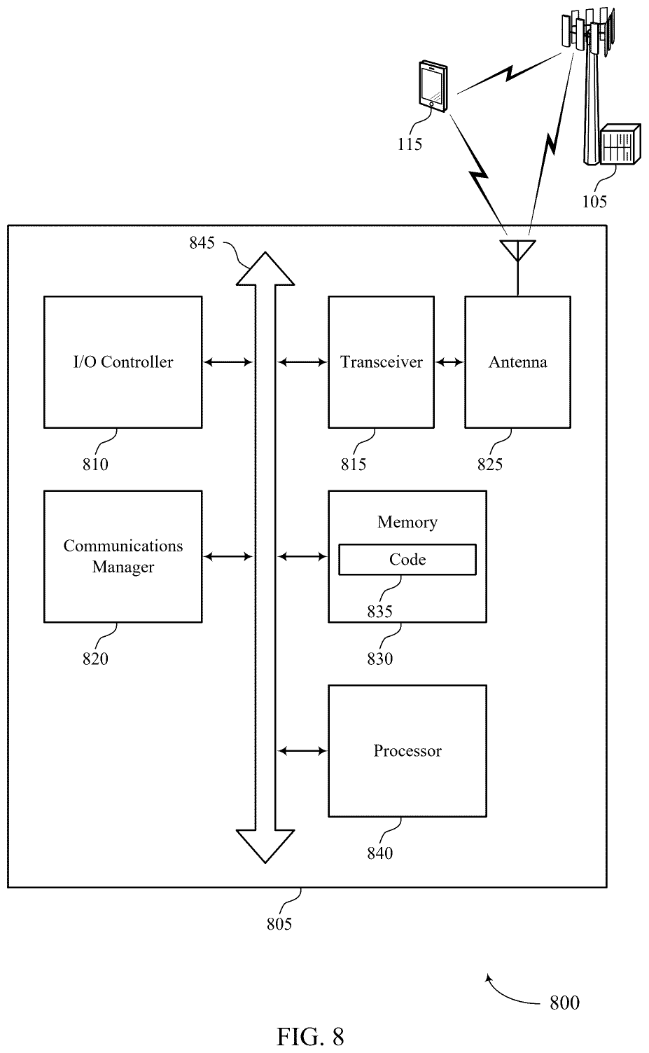

FIG. 8 shows a diagram of a system 800 including a device 805 that supports power control for additional activated ROs in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting power control for additional activated ROs). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving first control signaling that schedules a first set of ROs, where the first control signaling indicates a first power control parameter. The communications manager 820 is capable of, configured to, or operable to support a means for transmitting a first RACH message via a first RO in accordance with the first power control parameter, where the first set of ROs includes the first RO. The communications manager 820 is capable of, configured to, or operable to support a means for receiving second control signaling that indicates activation of an additional RO. The communications manager 820 is capable of, configured to, or operable to support a means for transmitting a second RACH message via a second RO in accordance with a second power control parameter based on the activation of the additional RO.

By including or configuring the communications manager 820 in accordance with examples as described herein, the device 805 may support techniques for improved communication reliability, reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of power control for additional activated ROs as described herein, or the at least one processor 840 and the at least one memory 830 may be otherwise configured to, individually or collectively, perform or support such operations.

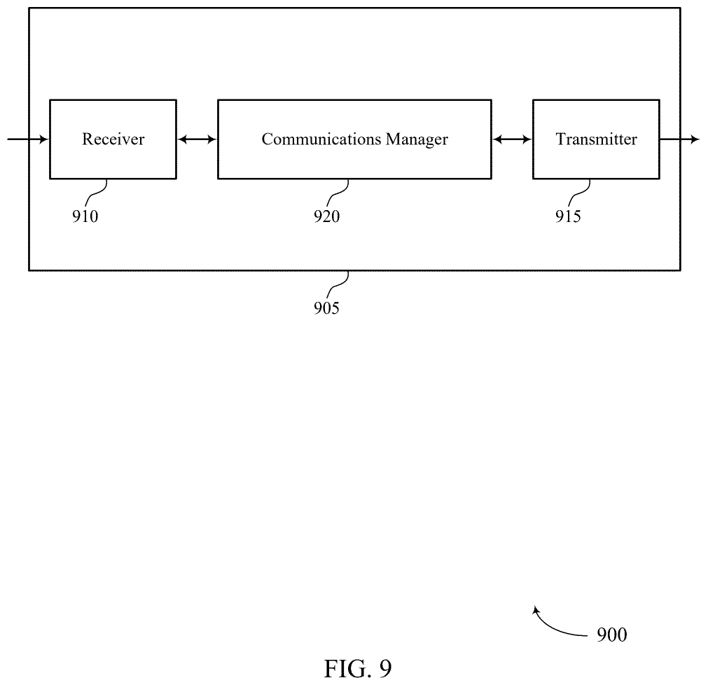

FIG. 9 shows a block diagram 900 of a device 905 that supports power control for additional activated ROs in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of power control for additional activated ROs as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, to a UE, first control signaling that schedules a first set of ROs, where the first control signaling indicates a first power control parameter. The communications manager 920 is capable of, configured to, or operable to support a means for receiving, from the UE, a first RACH message via a first RO in accordance with the first power control parameter, where the first set of ROs includes the first RO. The communications manager 920 is capable of, configured to, or operable to support a means for transmitting, to the UE, second control signaling that indicates activation of an additional RO. The communications manager 920 is capable of, configured to, or operable to support a means for receiving, from the UE, a second RACH message via a second RO in accordance with a second power control parameter based on the activation of the additional RO.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

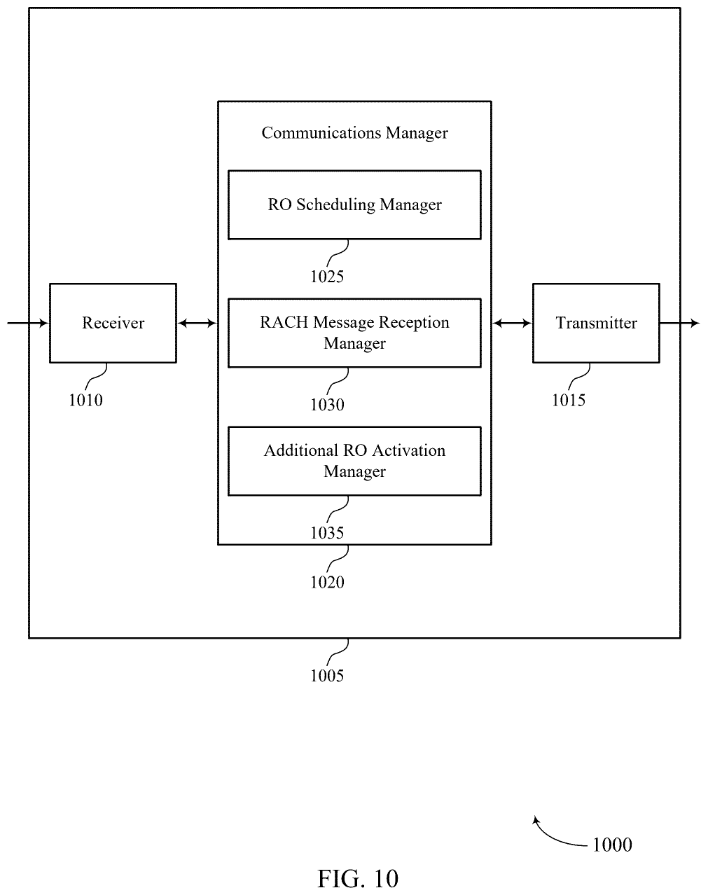

FIG. 10 shows a block diagram 1000 of a device 1005 that supports power control for additional activated ROs in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of power control for additional activated ROS as described herein. For example, the communications manager 1020 may include an RO scheduling manager 1025, a RACH message reception manager 1030, an additional RO activation manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The RO scheduling manager 1025 is capable of, configured to, or operable to support a means for transmitting, to a UE, first control signaling that schedules a first set of ROs, where the first control signaling indicates a first power control parameter. The RACH message reception manager 1030 is capable of, configured to, or operable to support a means for receiving, from the UE, a first RACH message via a first RO in accordance with the first power control parameter, where the first set of ROs includes the first RO. The additional RO activation manager 1035 is capable of, configured to, or operable to support a means for transmitting, to the UE, second control signaling that indicates activation of an additional RO. The RACH message reception manager 1030 is capable of, configured to, or operable to support a means for receiving, from the UE, a second RACH message via a second RO in accordance with a second power control parameter based on the activation of the additional RO.

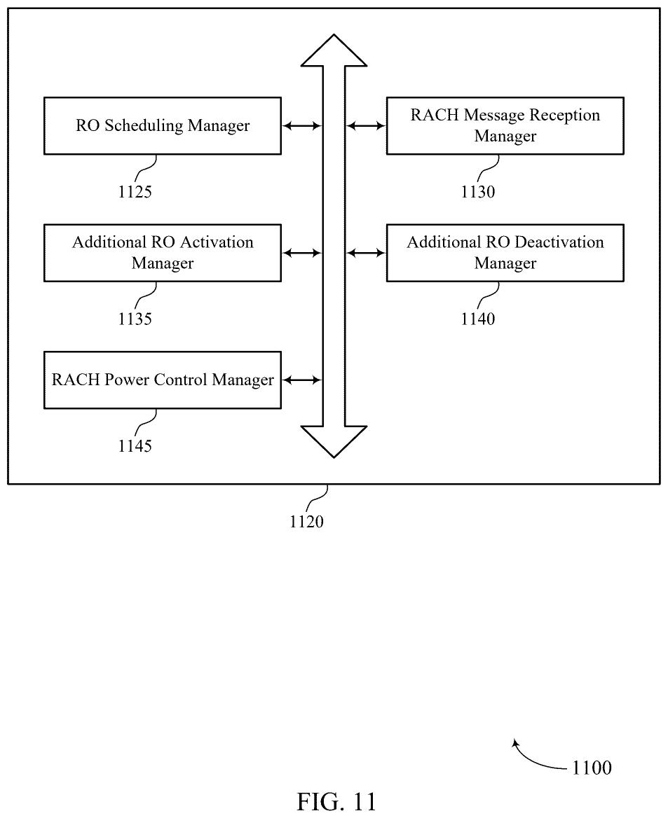

FIG. 11 shows a block diagram 1100 of a communications manager 1120 that supports power control for additional activated ROs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of power control for additional activated ROs as described herein. For example, the communications manager 1120 may include an RO scheduling manager 1125, a RACH message reception manager 1130, an additional RO activation manager 1135, an additional RO deactivation manager 1140, a RACH power control manager 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The RO scheduling manager 1125 is capable of, configured to, or operable to support a means for transmitting, to a UE, first control signaling that schedules a first set of ROs, where the first control signaling indicates a first power control parameter. The RACH message reception manager 1130 is capable of, configured to, or operable to support a means for receiving, from the UE, a first RACH message via a first RO in accordance with the first power control parameter, where the first set of ROs includes the first RO. The additional RO activation manager 1135 is capable of, configured to, or operable to support a means for transmitting, to the UE, second control signaling that indicates activation of an additional RO. In some examples, the RACH message reception manager 1130 is capable of, configured to, or operable to support a means for receiving, from the UE, a second RACH message via a second RO in accordance with a second power control parameter based on the activation of the additional RO.

In some examples, the first set of ROs includes the second RACH message.

In some examples, the RACH message reception manager 1130 is capable of, configured to, or operable to support a means for receiving, from the UE, a third RACH message via a third RO in accordance with the second power control parameter and based on the activation of the additional RO, where the additional RO includes the first RO.

In some examples, to support receiving the second RACH message, the RACH message reception manager 1130 is capable of, configured to, or operable to support a means for receiving the second RACH message in accordance with the second power control parameter based on the additional RO including the second RO.

In some examples, the RACH message reception manager 1130 is capable of, configured to, or operable to support a means for receiving, from the UE subsequent to reception of the second control signaling, a third RACH message via a third RO in accordance with the first power control parameter based on the first set of ROs including the third RO.

In some examples, the additional RO deactivation manager 1140 is capable of, configured to, or operable to support a means for transmitting, to the UE subsequent to transmission of the second RACH message, third control signaling that indicates deactivation of the additional RO. In some examples, the RACH message reception manager 1130 is capable of, configured to, or operable to support a means for receiving, from the UE subsequent to reception of the third control signaling, a third RACH message via a third RO in accordance with the first power control parameter based on the deactivation of the additional RO, where the first set of ROs includes the third RO.

In some examples, the first power control parameter includes a first ramping increment between subsequent RACH messages. In some examples, the second power control parameter includes a second ramping increment between subsequent RACH messages different from the first ramping increment between subsequent RACH messages.

In some examples, the second power control parameter includes a power offset with respect to the first power control parameter.

In some examples, the first power control parameter includes a first maximum transmission power. In some examples, the second power control parameter includes a second maximum transmission power different than the first maximum transmission power.

In some examples, the RACH power control manager 1145 is capable of, configured to, or operable to support a means for transmitting, to the UE via the first control signaling or the second control signaling, an indication of the second power control parameter.

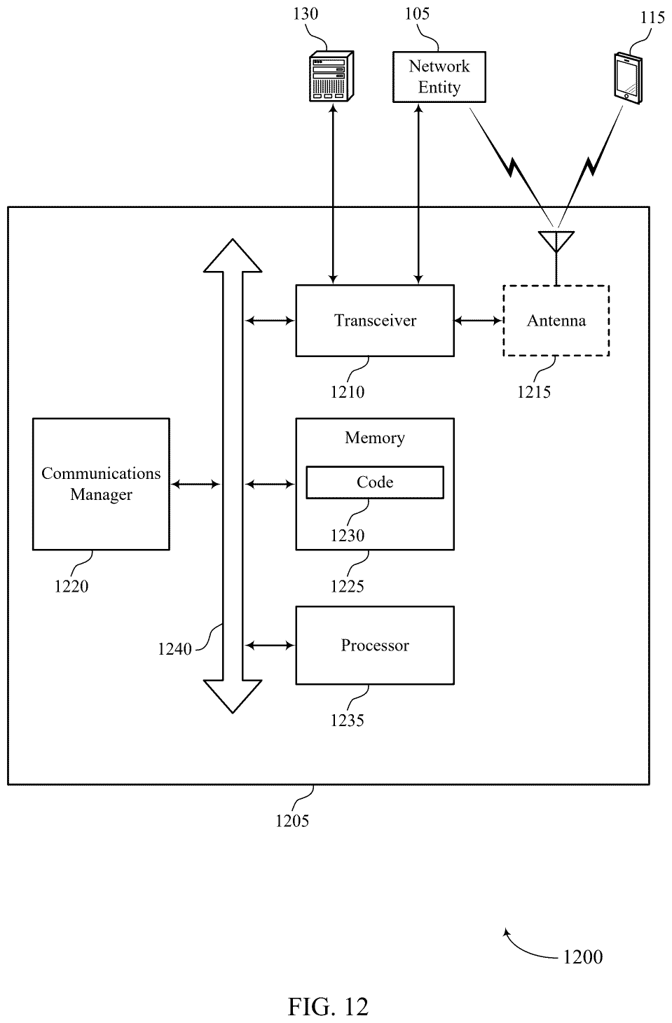

FIG. 12 shows a diagram of a system 1200 including a device 1205 that supports power control for additional activated ROs in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting power control for additional activated ROs). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting, to a UE, first control signaling that schedules a first set of ROs, where the first control signaling indicates a first power control parameter. The communications manager 1220 is capable of, configured to, or operable to support a means for receiving, from the UE, a first RACH message via a first RO in accordance with the first power control parameter, where the first set of ROs includes the first RO. The communications manager 1220 is capable of, configured to, or operable to support a means for transmitting, to the UE, second control signaling that indicates activation of an additional RO. The communications manager 1220 is capable of, configured to, or operable to support a means for receiving, from the UE, a second RACH message via a second RO in accordance with a second power control parameter based on the activation of the additional RO.

By including or configuring the communications manager 1220 in accordance with examples as described herein, the device 1205 may support techniques for improved communication reliability, reduced latency, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of power control for additional activated ROS as described herein, or the at least one processor 1235 and the at least one memory 1225 may be otherwise configured to, individually or collectively, perform or support such operations.

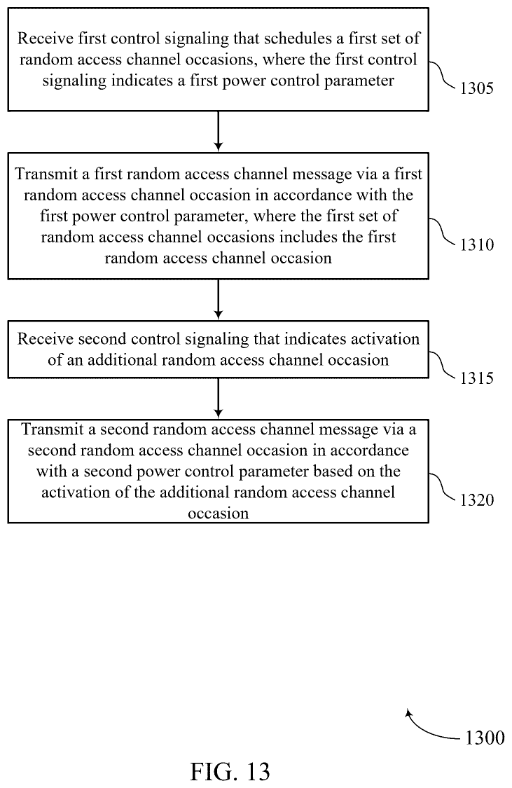

FIG. 13 shows a flowchart illustrating a method 1300 that supports power control for additional activated ROs in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving first control signaling that schedules a first set of ROs, where the first control signaling indicates a first power control parameter. The operations of 1305 may be performed in accordance with examples as disclosed herein. In some examples, aspects of the operations of 1305 may be performed by an RO scheduling manager 725 as described with reference to FIG. 7.

At 1310, the method may include transmitting a first RACH message via a first RO in accordance with the first power control parameter, where the first set of ROs includes the first RO. The operations of 1310 may be performed in accordance with examples as disclosed herein. In some examples, aspects of the operations of 1310 may be performed by a RACH message transmission manager 730 as described with reference to FIG. 7.

At 1315, the method may include receiving second control signaling that indicates activation of an additional RO. The operations of 1315 may be performed in accordance with examples as disclosed herein. In some examples, aspects of the operations of 1315 may be performed by an additional RO activation manager 735 as described with reference to FIG. 7.

At 1320, the method may include transmitting a second RACH message via a second RO in accordance with a second power control parameter based on the activation of the additional RO. The operations of 1320 may be performed in accordance with examples as disclosed herein. In some examples, aspects of the operations of 1320 may be performed by a RACH message transmission manager 730 as described with reference to FIG. 7.

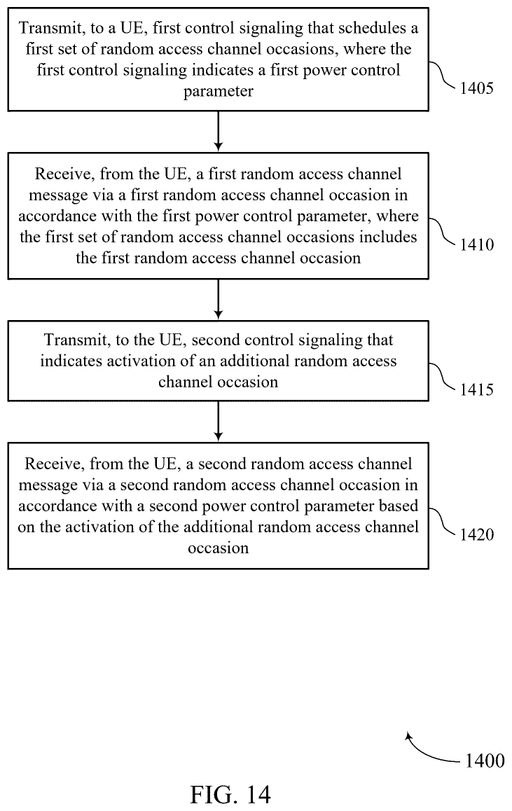

FIG. 14 shows a flowchart illustrating a method 1400 that supports power control for additional activated ROs in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting, to a UE, first control signaling that schedules a first set of ROs, where the first control signaling indicates a first power control parameter. The operations of 1405 may be performed in accordance with examples as disclosed herein. In some examples, aspects of the operations of 1405 may be performed by an RO scheduling manager 1125 as described with reference to FIG. 11.

At 1410, the method may include receiving, from the UE, a first RACH message via a first RO in accordance with the first power control parameter, where the first set of ROs includes the first RO. The operations of 1410 may be performed in accordance with examples as disclosed herein. In some examples, aspects of the operations of 1410 may be performed by a RACH message reception manager 1130 as described with reference to FIG. 11.

At 1415, the method may include transmitting, to the UE, second control signaling that indicates activation of an additional RO. The operations of 1415 may be performed in accordance with examples as disclosed herein. In some examples, aspects of the operations of 1415 may be performed by an additional RO activation manager 1135 as described with reference to FIG. 11.

At 1420, the method may include receiving, from the UE, a second RACH message via a second RO in accordance with a second power control parameter based on the activation of the additional RO. The operations of 1420 may be performed in accordance with examples as disclosed herein. In some examples, aspects of the operations of 1420 may be performed by a RACH message reception manager 1130 as described with reference to FIG. 11.

The following provides an overview of aspects of the present disclosure:
Aspect 1: A method for wireless communications at a UE, comprising: receiving first control signaling that schedules a first set of ROs, wherein the first control signaling indicates a first power control parameter; transmitting a first RACH message via a first RO in accordance with the first power control parameter, wherein the first set of ROs comprises the first RO; receiving second control signaling that indicates activation of an additional RO; and transmitting a second RACH message via a second RO in accordance with a second power control parameter based at least in part on the activation of the additional RO.
Aspect 2: The method of aspect 1, wherein the first set of ROs comprises the second RACH message.
Aspect 3: The method of aspect 2, further comprising: transmitting a third RACH message via a third RO in accordance with the second power control parameter and based at least in part on the activation of the additional RO, wherein the additional RO comprises the first RO.
Aspect 4: The method of aspect 1, wherein transmitting the second RACH message comprises: transmitting the second RACH message in accordance with the second power control parameter based at least in part on the additional RO comprising the second RO.
Aspect 5: The method of aspect 4, further comprising: transmitting, subsequent to reception of the second control signaling, a third RACH message via a third RO in accordance with the first power control parameter based at least in part on the first set of ROs comprising the third RO.
Aspect 6: The method of any of aspects 1 through 5, further comprising: resetting a power control accumulator parameter based at least in part on the activation, wherein the second power control parameter comprises the power control accumulator parameter.
Aspect 7: The method of any of aspects 1 through 6, further comprising: receiving, subsequent to transmission of the second RACH message, third control signaling that indicates deactivation of the additional RO; and transmitting, subsequent to reception of the third control signaling, a third RACH message via a third RO in accordance with the first power control parameter based at least in part on the deactivation of the additional RO, wherein the first set of ROs comprises the third RO.
Aspect 8: The method of aspect 7, further comprising: resetting a power control accumulator parameter based at least in part on the activation, wherein the first power control parameter comprises the power control accumulator parameter.
Aspect 9: The method of any of aspects 1 through 8, wherein the first power control parameter comprises a first ramping increment between subsequent RACH messages, and the second power control parameter comprises a second ramping increment between subsequent RACH messages different from the first ramping increment between subsequent RACH messages.
Aspect 10: The method of any of aspects 1 through 9, wherein the second power control parameter comprises a power offset with respect to the first power control parameter.
Aspect 11: The method of any of aspects 1 through 10, wherein the first power control parameter comprises a first maximum transmission power, and the second power control parameter comprises a second maximum transmission power different than the first maximum transmission power.
Aspect 12: The method of any of aspects 1 through 11, further comprising: receiving, via the first control signaling or the second control signaling, an indication of the second power control parameter.
Aspect 13: A method for wireless communications at a network entity, comprising: transmitting, to a UE, first control signaling that schedules a first set of ROs, wherein the first control signaling indicates a first power control parameter; receiving, from the UE, a first RACH message via a first RO in accordance with the first power control parameter, wherein the first set of ROs comprises the first RO; transmitting, to the UE, second control signaling that indicates activation of an additional RO; and receiving, from the UE, a second RACH message via a second RO in accordance with a second power control parameter based at least in part on the activation of the additional RO.
Aspect 14: The method of aspect 13, wherein the first set of ROs comprises the second RACH message.
Aspect 15: The method of aspect 14, further comprising: receiving, from the UE, a third RACH message via a third RO in accordance with the second power control parameter and based at least in part on the activation of the additional RO, wherein the additional RO comprises the first RO.
Aspect 16: The method of aspect 13, wherein receiving the second RACH message comprises: receiving the second RACH message in accordance with the second power control parameter based at least in part on the additional RO comprising the second RO.
Aspect 17: The method of aspect 16, further comprising: receiving, from the UE subsequent to reception of the second control signaling, a third RACH message via a third RO in accordance with the first power control parameter based at least in part on the first set of ROs comprising the third RO.
Aspect 18: The method of any of aspects 13 through 17, further comprising: transmitting, to the subsequent to transmission of the second RACH message, third control signaling that indicates deactivation of the additional RO; and receiving, from the UE subsequent to reception of the third control signaling, a third RACH message via a third RO in accordance with the first power control parameter based at least in part on the deactivation of the additional RO, wherein the first set of ROs comprises the third RO.
Aspect 19: The method of any of aspects 13 through 18, wherein the first power control parameter comprises a first ramping increment between subsequent RACH messages, and the second power control parameter comprises a second ramping increment between subsequent RACH messages different from the first ramping increment between subsequent RACH messages.
Aspect 20: The method of any of aspects 13 through 19, wherein the second power control parameter comprises a power offset with respect to the first power control parameter.
Aspect 21: The method of any of aspects 13 through 20, wherein the first power control parameter comprises a first maximum transmission power, and the second power control parameter comprises a second maximum transmission power different than the first maximum transmission power.
Aspect 22: The method of any of aspects 13 through 21, further comprising: transmitting, to the UE via the first control signaling or the second control signaling, an indication of the second power control parameter.
Aspect 23: A UE for wireless communications, comprising one or more memories storing processor-executable code, and one or more processors coupled with the one or more memories and individually or collectively operable to execute the code to cause the UE to perform a method of any of aspects 1 through 12.
Aspect 24: A UE for wireless communications, comprising at least one means for performing a method of any of aspects 1 through 12.
Aspect 25: A non-transitory computer-readable medium storing code for wireless communications, the code comprising instructions executable by one or more processors to perform a method of any of aspects 1 through 12.
Aspect 26: A network entity for wireless communications, comprising one or more memories storing processor-executable code, and one or more processors coupled with the one or more memories and individually or collectively operable to execute the code to cause the network entity to perform a method of any of aspects 13 through 22.
Aspect 27: A network entity for wireless communications, comprising at least one means for performing a method of any of aspects 13 through 22.
Aspect 28: A non-transitory computer-readable medium storing code for wireless communications, the code comprising instructions executable by one or more processors to perform a method of any of aspects 13 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” Also, as used herein, the phrase “a set” shall be construed as including the possibility of a set with one member. That is, the phrase “a set” shall be construed in the same manner as “one or more.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling that schedules a first set of random access channel occasions, wherein the first control signaling indicates a first power control parameter;
transmit a first random access channel message via a first random access channel occasion in accordance with the first power control parameter, wherein the first set of random access channel occasions comprises the first random access channel occasion;
receive second control signaling that indicates activation of an additional random access channel occasion; and
transmit a second random access channel message via a second random access channel occasion in accordance with a second power control parameter based at least in part on the activation of the additional random access channel occasion.

2. The UE of claim 1, wherein the first set of random access channel occasions comprises the second random access channel message.

3. The UE of claim 2, wherein the one or more processors are individually or collectively further operable to execute the code to cause the UE to:
transmit a third random access channel message via a third random access channel occasion in accordance with the second power control parameter and based at least in part on the activation of the additional random access channel occasion, wherein the additional random access channel occasion comprises the first random access channel occasion.

4. The UE of claim 1, wherein, to transmit the second random access channel message, the one or more processors are individually or collectively operable to execute the code to cause the UE to:
transmit the second random access channel message in accordance with the second power control parameter based at least in part on the additional random access channel occasion comprising the second random access channel occasion.

5. The UE of claim 4, wherein the one or more processors are individually or collectively further operable to execute the code to cause the UE to:
transmit, subsequent to reception of the second control signaling, a third random access channel message via a third random access channel occasion in accordance with the first power control parameter based at least in part on the first set of random access channel occasions comprising the third random access channel occasion.

6. The UE of claim 1, wherein the one or more processors are individually or collectively further operable to execute the code to cause the UE to:
reset a power control accumulator parameter based at least in part on the activation, wherein the second power control parameter comprises the power control accumulator parameter.

7. The UE of claim 1, wherein the one or more processors are individually or collectively further operable to execute the code to cause the UE to:
receive, subsequent to transmission of the second random access channel message, third control signaling that indicates deactivation of the additional random access channel occasion; and
transmit, subsequent to reception of the third control signaling, a third random access channel message via a third random access channel occasion in accordance with the first power control parameter based at least in part on the deactivation of the additional random access channel occasion, wherein the first set of random access channel occasions comprises the third random access channel occasion.

8. The UE of claim 7, wherein the one or more processors are individually or collectively further operable to execute the code to cause the UE to:
reset a power control accumulator parameter based at least in part on the activation, wherein the first power control parameter comprises the power control accumulator parameter.

9. The UE of claim 1, wherein:
the first power control parameter comprises a first ramping increment between subsequent random access channel messages, and
the second power control parameter comprises a second ramping increment between subsequent random access channel messages different from the first ramping increment between subsequent random access channel messages.

10. The UE of claim 1, wherein the second power control parameter comprises a power offset with respect to the first power control parameter.

11. The UE of claim 1, wherein:
the first power control parameter comprises a first maximum transmission power, and
the second power control parameter comprises a second maximum transmission power different than the first maximum transmission power.

12. The UE of claim 1, wherein the one or more processors are individually or collectively further operable to execute the code to cause the UE to:
receive, via the first control signaling or the second control signaling, an indication of the second power control parameter.

13. A method for wireless communications at a user equipment (UE), comprising:
receiving first control signaling that schedules a first set of random access channel occasions, wherein the first control signaling indicates a first power control parameter;
transmitting a first random access channel message via a first random access channel occasion in accordance with the first power control parameter, wherein the first set of random access channel occasions comprises the first random access channel occasion;
receiving second control signaling that indicates activation of an additional random access channel occasion; and
transmitting a second random access channel message via a second random access channel occasion in accordance with a second power control parameter based at least in part on the activation of the additional random access channel occasion.

14. The method of claim 13, wherein the first set of random access channel occasions comprises the second random access channel message.

15. The method of claim 14, further comprising:
transmitting a third random access channel message via a third random access channel occasion in accordance with the second power control parameter and based at least in part on the activation of the additional random access channel occasion, wherein the additional random access channel occasion comprises the first random access channel occasion.

16. The method of claim 13, wherein transmitting the second random access channel message comprises:
transmitting the second random access channel message in accordance with the second power control parameter based at least in part on the additional random access channel occasion comprising the second random access channel occasion.

17. The method of claim 16, further comprising:
transmitting, subsequent to reception of the second control signaling, a third random access channel message via a third random access channel occasion in accordance with the first power control parameter based at least in part on the first set of random access channel occasions comprising the third random access channel occasion.

18. The method of claim 13, further comprising:
resetting a power control accumulator parameter based at least in part on the activation, wherein the second power control parameter comprises the power control accumulator parameter.

19. The method of claim 13, further comprising:
receiving, subsequent to transmission of the second random access channel message, third control signaling that indicates deactivation of the additional random access channel occasion; and
transmitting, subsequent to reception of the third control signaling, a third random access channel message via a third random access channel occasion in accordance with the first power control parameter based at least in part on the deactivation of the additional random access channel occasion, wherein the first set of random access channel occasions comprises the third random access channel occasion.

20. A non-transitory computer-readable medium storing code for wireless communications by a user equipment (UE), the code comprising instructions executable by one or more processors to:
receive first control signaling that schedules a first set of random access channel occasions, wherein the first control signaling indicates a first power control parameter;
transmit a first random access channel message via a first random access channel occasion in accordance with the first power control parameter, wherein the first set of random access channel occasions comprises the first random access channel occasion;
receive second control signaling that indicates activation of an additional random access channel occasion; and
transmit a second random access channel message via a second random access channel occasion in accordance with a second power control parameter based at least in part on the activation of the additional random access channel occasion.
